(19) United States
(12) Patent Application Publication
(10) Pub. No.: US 2005/0064174 A1
(43) Pub. Date: Mar. 24, 2005

(54) Reaction injection molded members and method of forming

(75) Inventors: David E. Gideon, Seattle, WA (US); Eugene A. Jackson, Renton, WA (US); David A. Vaughan, Stanwood, WA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/666,109

(22) Filed: Sep. 18, 2003

(51) Int. Cl. B32B 3/26

(52) U.S. Cl. 428/317.9; 428/131; 428/99; 428/71

(57) ABSTRACT

Reaction injection molded (RIM) members and a method for forming such members are provided. The members can be formed in a mold cavity defining a contour that corresponds to the desired contour of the members. A foam material, such as a combination of polyol and isocyanate is injected into the cavity with a blowing agent so that the foam material expands to form the low density member. The average density of the member can be less than about 6 pounds per cubic foot.

### BACKGROUND OF THE INVENTION

1) Field of the Invention

The present invention relates to reaction injection molding of members and, in particular, members formed by reaction injection molding with improved properties, such as reduced density and improved fireworthiness.

2) Description of Related Art

Reaction injection molding is conventionally used in the manufacture of members for medical devices, sporting equipment, and automobile trim parts. In one typical manufacturing method, first and second dies of a molding tool are used to form the part. With the dies in an open configuration, a liquid foaming material is dispensed onto a surface of one or both of the dies. The dies are then closed to encapsulate the foaming material in a cavity defined between the dies. The foaming material expands to fill the cavity, dries and hardens to form the foam part with a shape that corresponds to the shape of the die cavity. In addition, a laminar layer of material can be disposed between one or more surfaces of the dies and the foaming material so that the laminar layer is joined to the foam and forms an outer surface of the finished part. Further, metal rods or other structural materials can be disposed in the die cavity to provide reinforcement within the foam of the finished part.

The characteristics of conventional reaction injection molded (RIM) parts do not meet the requisite standards for some applications. For example, in the aerospace industry, part weight is an important consideration for many vehicles and structures, and conventional RIM parts often exceed the maximum allowable part weights. Further, conventional RIM parts do not sufficiently resist burning or other fire penetration as required for many aerospace applications.

Thus, there exists a need for an improved method for reaction injection molding and parts formed thereby. Preferably, the parts should have a low density. Further the parts should be sufficiently fire resistant or compatible with methods for enhancing fire resistant properties.

### BRIEF SUMMARY OF THE INVENTION

The present invention provides a reaction injection molded (RIM) member and a method for forming a RIM member. The foam of the member can be formed from a foam material that includes a blowing agent so that the foam material expands to form a low density member, for example, with an average density less than about 6 pounds per cubic foot.

According to one embodiment of the present invention, a RIM member having a desired contour is formed by providing a mold defining a cavity with a contour that corresponds to the desired contour of the member and injecting a foam material into the cavity. The foam material, which includes a blowing agent, such as in an amount of between about 3.5% and 12.5% by weight, is disposed against the contour of the cavity and expands to form the member with an average density of less than about 6 pounds per cubic foot. The free rise density of the foam material can be less than about 3 pounds per cubic foot, and the maximum density of the foam can be less than about 10 pounds per cubic foot or, in some embodiments, less than about 6 pounds per cubic foot. The foam of the resulting member can be polyurethane formed from a foam material that includes polyol and isocyanate, for example, between about 50% and 65% by weight isocyanate. The foam material can also include a fire resistant additive, such as phosphoric acid in an amount of at least about 1% by weight.

According to one aspect of the present invention, at least one elongate support member is disposed in the cavity so that the foam forms at least partially around the support member and the support member increases the strength and/or stiffness of the RIM member. The support member, which can be formed of reinforced thermoplastic laminate, Tedlar®, or fiberglass, can be disposed against the contour surface of the mold so that the support member defines a surface of the RIM member. One or more fasteners can be disposed in the cavity so that the member is formed with the fastener(s) at least partially disposed therein.

The mold cavity and, hence, the RIM member, can correspond to the shape of an aircraft stowage bin, the stowage bin defining an elongate portion having first and second sides and extending between first and second end portions, the elongate and end portions defining a stowage space therein. Alternatively, the mold cavity and the resulting RIM member can correspond to the shape of an interior panel for an aircraft, the panel defining first and second opposite elongate surfaces. Thus, the stowage bin and interior panels can be formed with a low density and/or sufficient fire resistance as required in the aerospace industry.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view illustrating an apparatus for forming a RIM member according to one embodiment of the present invention, shown in an open configuration;

FIG. 2 is a perspective view illustrating a RIM member for an aircraft stowage bin formed using the apparatus of FIG. 1;

FIG. 3 is a sectional view in elevation illustrating the RIM member of FIG. 2;

FIG. 4 is a perspective view illustrating a RIM panel for the interior of an aircraft formed according to another embodiment of the present invention; and

FIG. 5 is a flow chart illustrating the operations for forming a RIM member according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

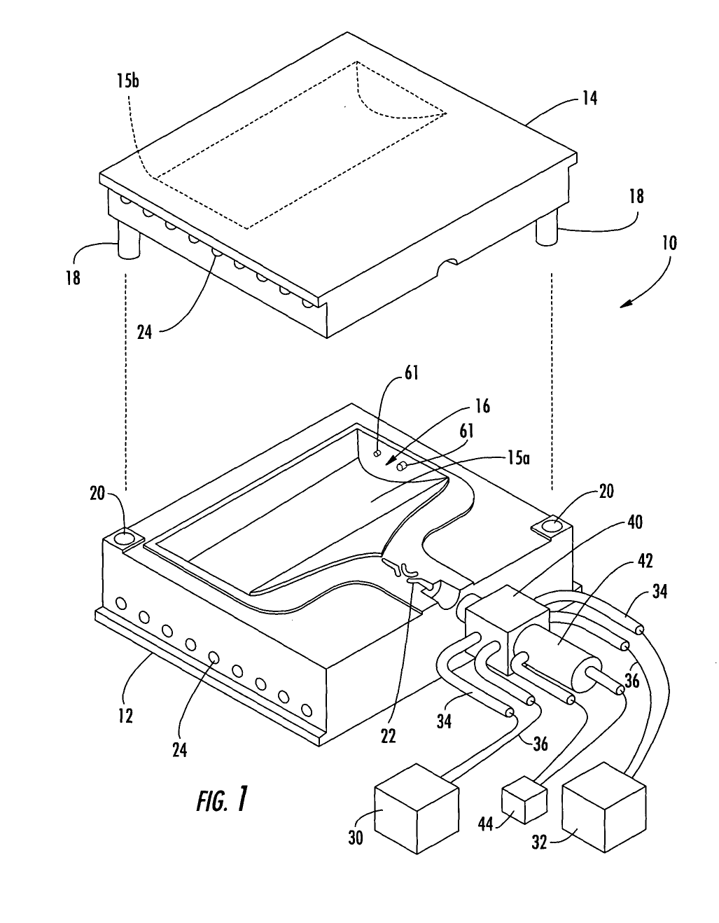

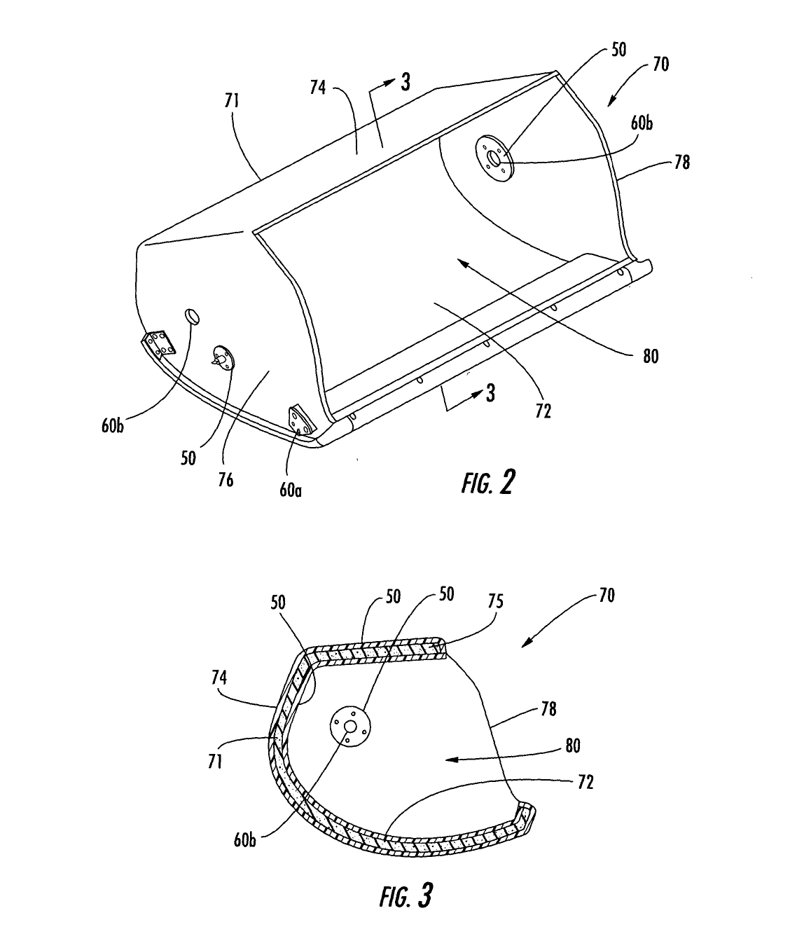

Referring now to the figures and, in particular, FIG. 1, there is shown an apparatus 10 for forming a reaction injection molded (RIM) member 70 (FIG. 2) according to one embodiment of the present invention. The apparatus 10 includes first and second co-operable mold members 12, 14 or dies that can be closed to form a mold defining a mold cavity 16. The mold cavity 16 has a predetermined contour that corresponds to the desired contour of the member 70. For example, the mold members 12, 14 shown in FIG. 1 correspond to the RIM member 70 shown in FIG. 2 for a stowage bin for an aircraft. The stowage bin 70 defines an elongate portion 71 having first and second opposite surfaces 72, 74 and extending between first and second end portions 76, 78. The elongate and end portions 71, 76, 78 define a stowage space 80 therein. Such a bin 70 can be used on an aircraft as an overhead luggage compartment. The stowage bin 70 can include a rotatable door (not shown) that is adjustable between open and closed positions so that the space 80 can be accessed for the stowing of luggage or other articles therein and then closed.

Referring again to FIG. 1, the first mold member 12 defines a generally concave surface 15a that corresponds to the outer surface 74 of the member 70, and the second mold member 14 defines a generally convex surface 15b that corresponds to the inner surface 72 of the member 70. The mold members 12, 14, which are shown in an open configuration, can be closed so that the first mold member 12 receives the second mold member 14 and the cavity 16 formed therebetween corresponds in shape to the RIM member 70. Alignment features can be provided on the mold members 12, 14, such as pins 18 and corresponding pin holes 20, and the mold members 12, 14 can be clamped or otherwise secured together. Further, the mold members 12, 14 can define passages 24 for receiving and circulating a coolant fluid to cool the apparatus 10 and the member 70 therein.

The RIM member 70 is formed of a foam material that is mixed and injected into the mold cavity 16. For example, as shown in FIG. 1, first and second vessels 30, 32 are provided for supplying agents of a foam material, such as isocyanate and polyol. Upon drying and hardening, the foam material forms a low-density foam 75 such as polyurethane foam. The vessels 30, 32 can be pressurized, or pumps (not shown) can be provided for delivering the agents of the foam material to a mix head 40. Each of the vessels 30, 32 can be fluidly connected to the mix head 40 by a supply line 34 and a return line 36 so that the agents can be circulated through the mix head 40 continuously before and after a mixing and injection operation. For example, the mixing head 40 can act as a valve that is adjustable between closed and open configurations. In the closed configuration, the first and second agents are circulated to the mixing head 40 by the supply lines 34, then through the mixing head 40 so that the agents do not mix in the mixing head 40 but instead continuously flow back to the respective vessels 30, 32 by the return lines 36. When the mix head 40 is actuated to the open position, for example, by a hydraulic actuator 42 controlled by a hydraulic fluid from a hydraulic source 44, the first and second agents are mixed in the head 40 to form the foam material. The foam material flows into the mold cavity 16 through an injection passage, known as a runner 22, which fluidly connects the mixing head 40 to the mold cavity 16. The runner 22 can be helically spiral or otherwise circuitous so that the foam material is further mixed in the runner 22.

The foam material flows into the mold cavity 16 and typically fills or substantially fills the mold cavity 16, i.e., the foam material is disposed in the cavity 16 so that the foam material expands against the contour surfaces 15a, 15b of the mold cavity 16. As the foam material is disposed in the cavity 16, and expands to fill the cavity 16, the foam material takes a desired shape corresponding to the contour surfaces 15a, 15b. After the foam material hardens, the member 70 can be removed from the apparatus 10, and the apparatus 10 can be re-used to form another member 70.

Various types of foam agents can be used to form the foam material and the resulting RIM member 70. According to one embodiment of the present invention, polyol and isocyanate are used to form a polyurethane foam. For example, the foam material can include between about 50% and 65% by weight of isocyanate and less than about 50% by weight of polyol. Preferably, a blowing agent is also included in the foam material. The blowing agent generally has a low evaporation temperature and therefore forms bubbles in the foam material, thereby expanding the foam material and decreasing the density of the foam 75. The blowing agent can be introduced separately to the mixing head 40 and mixed therein with the foam agents. Alternatively, the blowing agent can be included in one of the foam agents, e.g., by providing the blowing agent with the foam agent in the respective vessel 30, 32, or by mixing the blowing agent with the foam agent while the foam agent flows to the mixing head 40. A variety of materials can be used as the blowing agent, e.g., Enovate® 3000 blowing agent, a registered trademark of Honeywell International Inc., having a molecular formula CF₃CH₂CHF₂ (1,1,1,3,3-pentafluoropropane).

The blowing agent generally results in a foam material that expands to a lower density, and hence a lighter foam 75, than a foam material formed without a blowing agent. Further, increasingly higher amounts of the blowing agent in the foam material generally result in lower density foams 75. Preferably, a sufficient amount of the blowing agent is used to result in a free rise density of the foam material that is less than about 3 pounds per cubic foot. The free rise density refers to the density of the foam 75 that results when the foam material is disposed under normal atmospheric conditions and not restrained, e.g., the foam material is disposed on a surface without a restraining mold cavity. For example, the foam material can include between about 3.5% and 12.5% by weight of the blowing agent. According to one embodiment of the present invention, the first foam agent, isocyanate, is provided from the first vessel 30 as 57% by weight of the foam material and the second foam agent, polyol, is provided in combination with the blowing agent from the second vessel 32 as the remaining 43% by weight of the foam material, the blowing agent comprising about 16% by weight of the polyol-blowing agent combination provided from the second vessel 32 (or about 7% by weight of the total foam material).

The average density of the foam 75 of the finished member 70, as formed in the mold cavity 16, can be less than about 6 pounds per cubic foot. The density of the foam 75 can vary throughout the member 70, and the maximum density can be, for example, less than about 10 pounds per cubic foot or, in another embodiment, less than about 6 pounds per cubic foot. In some embodiments, the density of the foam 75 can be less than about 3 pounds per cubic foot. Advantageously, such densities of the foam 75 can provide a combination of high strength and low weight as desired, or required, in certain applications for the members 70, for example, for members used in the aerospace industry, automotive industry, and the like.

Additional materials can also be added to the foam material, for example, to change the properties of the foam 75 and, hence, the member 70. For example, additives such as phosphoric acid can be added to increase the fire worthiness of the foam 75 so that the resulting RIM member 70 is fire resistant. According to one embodiment of the present invention, the foam material is at least about 1% by weight phosphoric acid. The additive(s) can be provided in combination with one or both of the foam agents in the vessels 30, 32 or the additives can be provided separately to the foam material, e.g., by an additional vessel fluidly connected to the mixing head 40.

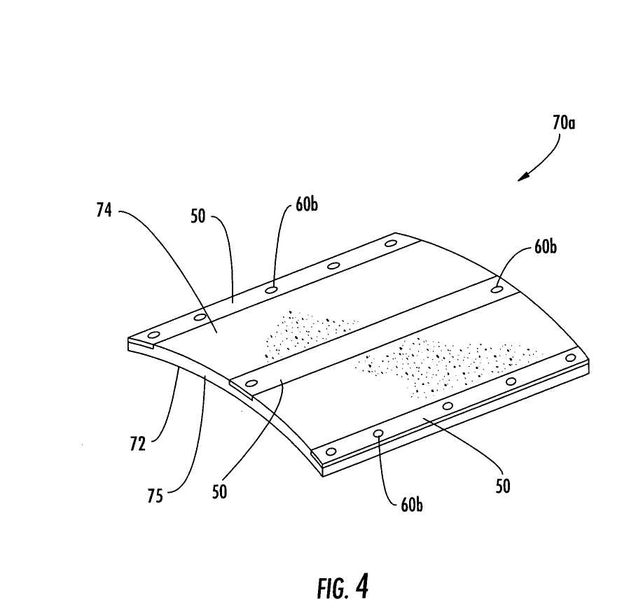

As shown in FIG. 3, support members 50 can be provided in the foam material, for example, to increase the strength and/or stiffness of the member 70. The support members 50 can be elongate members formed of various materials including, for example, reinforced thermoplastic laminate, fiberglass, or polyvinyl fluoride (PVF) such as Tedlar®, a registered trademark of E. I. du Pont de Nemours and Co. Each support member 50 can be disposed in the mold cavity 16 with the foam material so that the foam material is disposed against the support member 50, the foam material is disposed partially around the support member 50, or the foam material fully surrounds the support member 50. Thus, as the foam material hardens to form the foam 75 of the member 70, each support member 50 can be secured to the foam 75. For example, according to one embodiment of the present invention, one or more support members 50 are disposed in the mold cavity 16 against one or more of the contour surfaces 15a, 15b of the mold members 12, 14. The foam material is then injected into the mold cavity 16 and disposed against the support member 50 so that the support member 50 defines an outer surface of the finished member 70. The support member 50 in such a configuration can provide strength to the exterior of the foam 75, thereby increasing the resistance of the member 70 to breaking, denting, puncturing, or otherwise deforming. Further, the support members 50 can provide a working surface that is smooth or rough, as desired according to the intended use of the member 70. The support members 50 can be rigid or flexible, and in some embodiments, can flex under light or moderate pressure so that the member 70 deforms slightly when touched and therefore has a “soft-touch” surface. The support members 50 can also define one or more aesthetic or functional characteristics, such as coloring, decorative patterns, and the like.

The support members 50 can be provided at locations in the RIM member 70 where strength and/or stiffness are desired, such as near portions that experience increased stress during use, so that the durability of the member 70 is improved. Further, as shown in FIGS. 2 and 3, the support members 50 can be provided on the first side 72 of the RIM member 70 and the opposite side 74 of the member 70, i.e., to sandwich the foam 75 between the opposite support members 50. The support members 50 can be disposed over portions or the entire surfaces of the foam 75, e.g., so that the foam 75 is covered on one or both sides of the RIM member 70 and the support members 50 define the inner and/or outer surfaces of the member 70.

As shown in FIGS. 2-4, one or more connection or other features can also be provided in the RIM member 70. For example, a fastening device 60a such as a bolt, nut, rivet, clip, bracket, and the like can be provided in the mold cavity 16 so that the foam material at least partially surrounds the fastening device 60a and, upon drying, anchors the fastening device 60a in place. Thus, the fastening device 60a can be anchored in the member 70, as shown in FIG. 2, and subsequently used to connect a hinge, latch, lock, handle, or other device to the member 70. Alternatively, the feature can be a hole, slot, or other aperture 60b, such as for receiving a fastening device. The molds members 12, 14 can define a corresponding protrusion 61 so that the resulting foam member 70 defines the aperture 60b. Further, the aperture 60b can extend through the support members 50 to receive a fastening device therethrough. Various other types of features can also be provided in the RIM member 70. For example, a portion of a hinge can be disposed in the die cavity 16 so that the hinge is anchored in the foam 75 of the member 70; a window or window frame can be disposed in the cavity 16 so that the foam 75 of the member 70 is connected to and sealed against the perimeter of the window or the window frame; or other devices can be similarly joined to the foam 75.

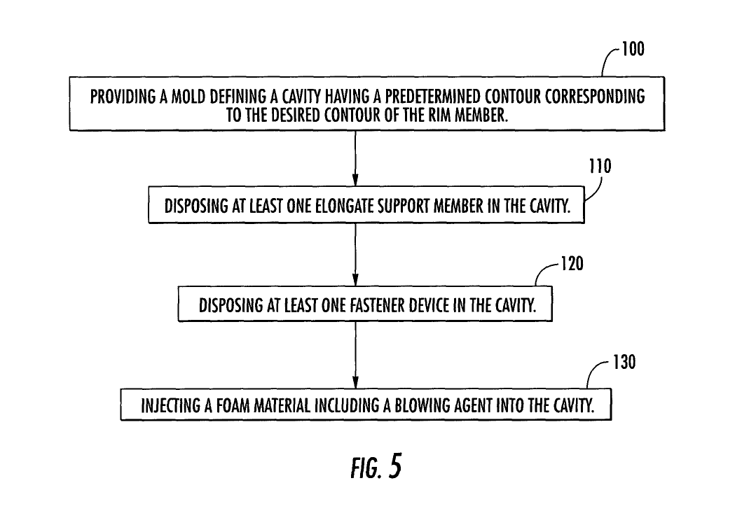

A variety of RIM members 70 can be formed according to the present invention. Advantageously, the low density that can be achieved in the foam 75 by the present invention provides a lightweight alternative to parts formed by conventional manufacturing methods such as plastic parts formed by injection molding. For example, the RIM members 70 can be interior parts for an aerospace vehicle, such as a stowage bin for an airplane (FIG. 2), other panels or portions for the interior of an aircraft, or interior or exterior parts for other aerospace, marine, or automotive vehicles. Further, the members can be used in any other structures or devices, especially where weight is a consideration, such as in medical and sporting equipment. FIG. 4 illustrates a panel 70a formed according to the present invention, such as can be used for an interior of an aircraft. The panel 70a is curved to correspond to the curvature of the interior of the aircraft, and elongate support members 50 are provided along the length of the panel to increase the strength and/or stiffness of the panel 70a. Fastener features and, more particularly, apertures 60b, extend through the panel 70a coincident with the support members 50. The apertures 60b can receive rivets, bolts, clips, or other fastening devices for connecting the interior panel 70a to the interior of the aircraft. Advantageously, the foam 75 of the panel 70a has a low density, less than about 10 pounds per cubic foot, preferably less than about 6 pounds per cubic foot.

FIG. 5 illustrates the operations for forming a RIM member according to one embodiment of the present invention, e.g., a RIM member corresponding in shape to a stowage bin for an aircraft or an interior panel for an aircraft. It is understood that one or more of the operations shown can be omitted and additional operations can be included without departing from the scope of the invention. In Block 100, a mold is provided, the mold defining a cavity having a predetermined contour corresponding to the desired contour of the RIM member. One or more elongate support members are provided in the cavity. See Block 110. The support members can be formed of materials including, but not limited to, reinforced thermoplastic laminate, polyvinyl fluoride, and fiberglass. Additionally, each support member can be disposed against the contour surface(s) of the mold so that the support members define one or more surfaces of the RIM member. For example, first and second support members can be disposed in an opposed configuration so that the first and second support members define opposite surfaces of the RIM member. One or more fastener devices are disposed in the cavity. See Block 120. A foam material is then injected into the cavity, the foam material including a blowing agent. See Block 130. The foam material can include sufficient blowing agent so that the foam material expands to an average density of less than about 6 pounds per cubic foot, a maximum density of less than about 10 pounds per cubic foot or less than about 6 pounds per cubic foot, or so that the foam material has a free rise density of less than about 3 pounds per cubic foot. For example, the foam material can include between about 3.5% and 12.5% by weight blowing agent. The foam material can also include polyol and between about 50% and 65% by weight isocyanate to form polyurethane foam. Further, a fire resistant additive can be injected, such as at least about 1% by weight phosphoric acid.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for making a reaction injection member having a desired contour, the method comprising:
providing a mold defining a cavity having a predetermined contour corresponding to the desired contour of the member; and
injecting a foam material including a blowing agent into the cavity such that the foam material is disposed against the predetermined contour and expands to form the member having an average density of less than about 6 pounds per cubic foot.

2. A method according to claim 1 wherein said injecting step comprises forming the member with a maximum density of less than about 10 pounds per cubic foot.

3. A method according to claim 1 wherein said injecting step comprises forming the member with a maximum density of less than about 6 pounds per cubic foot.

4. A method according to claim 1 wherein said injecting step comprises injecting the foam material with a free rise density of less than about 3 pounds per cubic foot.

5. A method according to claim 1 wherein said injecting step comprises injecting the foam material including between about 3.5% and 12.5% by weight of the blowing agent.

6. A method according to claim 1 wherein said injecting step comprises injecting the foam material including polyol and between about 50% and 65% by weight isocyanate to form polyurethane foam.

7. A method according to claim 1 wherein said injecting step further comprises injecting a fire resistant additive such that the member is fire resistant.

8. A method according to claim 1 wherein said injecting step comprises injecting the foam material including at least about 1% by weight phosphoric acid.

9. A method according to claim 1 further comprising disposing at least one elongate support member in the cavity such that the foam forms at least partially around the support member.

10. A method according to claim 9 wherein said disposing step comprises disposing at least one support member formed of at least one of the group consisting of reinforced thermoplastic laminate, polyvinyl fluoride, and fiberglass.

11. A method according to claim 9 wherein said disposing step comprises disposing the at least one support member against the mold such that the support member defines a surface of the member.

12. A method according to claim 9 wherein said disposing step comprises first and second support members against the mold in an opposed configuration such that the first and second support members define opposite surfaces of the member.

13. A method according to claim 1 further comprising disposing at least one fastener device in the cavity before said injecting step such that the member is formed with the at least one fastener device at least partially disposed within the member.

14. A method according to claim 1 further comprising forming at least one aperture in the member and disposing a fastener device at least partially in the aperture.

15. A method according to claim 1 further comprising disposing a feature member in the cavity before said injecting step such that the member is formed with the feature member at least partially disposed within the member, the feature member comprising at least one of the group consisting of a hinge, a window, and a window frame.

16. A method according to claim 1 wherein the mold cavity corresponds to the shape of a stowage bin for an aircraft, the stowage bin defining an elongate portion having first and second sides and extending between first and second end portions, the elongate and end portions defining a stowage space therein.

17. A method according to claim 1 wherein the mold cavity corresponds to the shape of an interior panel for an aircraft, the panel defining first and second opposite elongate surfaces.

18. A reaction injection molded member, the member comprising:
expanded polyurethane foam material having first and second opposite surfaces defining a desired contour, the foam material including polyol and between about 50% and 65% by weight isocyanate and having an average density of less than about 6 pounds per cubic foot.

19. A reaction injection molded member according to claim 18 wherein the foam material has a maximum density of less than about 10 pounds per cubic foot.

20. A reaction injection molded member according to claim 18 wherein the foam material has a maximum density of less than about 6 pounds per cubic foot.

21. A reaction injection molded member according to claim 18 wherein the foam material has a free rise density of less than about 3 pounds per cubic foot

22. A reaction injection molded member according to claim 18 wherein the foam material includes between about 3.5% and 12.5% by weight of a blowing agent.

23. A reaction injection molded member according to claim 18 wherein the foam material includes a fire resistant additive such that the member is fire resistant.

24. A reaction injection molded member according to claim 23 wherein the foam material includes at least about 1% phosphoric acid by weight of the foam.

25. A reaction injection molded member according to claim 18 further comprising at least one support member extending longitudinally in member and at least partially enclosed by the foam.

26. A reaction injection molded member according to claim 25 wherein the at least one support member comprises a member formed of at least one of the group consisting of reinforced thermoplastic laminate, polyvinyl fluoride, and fiberglass.

27. A reaction injection molded member according to claim 25 wherein at least one support member defines a surface of the member.

28. A reaction injection molded member according to claim 27 wherein the member includes first and second support members defining opposite surfaces of the member.

29. A reaction injection molded member according to claim 18 further comprising at least one fastener device at least partially disposed within the member.

30. A reaction injection molded member according to claim 18 further comprising at least one feature member at least partially disposed within the reaction injection molded member, the feature member comprising at least one of the group consisting of a hinge, a window, and a window frame.

31. A reaction injection molded member according to claim 18 wherein the member is a stowage bin for an aircraft, the stowage bin defining an elongate portion having first and second sides and extending between first and second end portions, the elongate and end portions defining a stowage space therein.

32. A reaction injection molded member according to claim 18 wherein the member is an interior panel for an aircraft, the panel defining first and second opposite elongate surfaces.

33. A reaction injection molded interior member for an aircraft, the member comprising:
expanded polyurethane foam material having first and second opposite surfaces defining a desired contour, the foam material including polyol, between about 50% and 65% by weight isocyanate, and between about 3.5% and 12.5% by weight of a blowing agent, the foam material having a free rise density of less than about 3 pounds per cubic foot, an average density of less than about 6 pounds per cubic foot, and a maximum density of less than about 10 pounds per cubic foot.

34. A reaction injection molded member according to claim 33 wherein the foam material has a maximum density of less than about 6 pounds per cubic foot.

35. A reaction injection molded member according to claim 33 wherein the foam material includes a fire resistant additive such that the member is fire resistant.

36. A reaction injection molded member according to claim 35 wherein the foam material includes at least about 1% phosphoric acid by weight of the foam.

37. A reaction injection molded member according to claim 33 further comprising at least one support member extending longitudinally in member and at least partially enclosed by the foam.

38. A reaction injection molded member according to claim 37 wherein the at least one support member comprises a member formed of at least one of the group consisting of reinforced thermoplastic laminate, polyvinyl fluoride, and fiberglass.

39. A reaction injection molded member according to claim 37 wherein at least one support member defines a surface of the member.

40. A reaction injection molded member according to claim 39 wherein the member includes first and second support members defining opposite surfaces of the member.

41. A reaction injection molded member according to claim 33 further comprising at least one fastener device at least partially disposed within the member.

42. A reaction injection molded member according to claim 33 wherein further comprising at least one feature member at least partially disposed within the reaction injection molded member, the feature member comprising at least one of the group consisting of a hinge, a window, and a window frame.

43. A reaction injection molded member according to claim 33 wherein the member is a stowage bin for an aircraft, the stowage bin defining an elongate portion having first and second sides and extending between first and second end portions, the elongate and end portions defining a stowage space therein.

44. A reaction injection molded member according to claim 33 wherein the member is an interior panel for an aircraft, the panel defining first and second opposite elongate surfaces.
